(19) United States
(12) Patent Application Publication
(10) Pub. No.: US 2005/0006192 A1
(43) Pub. Date: Jan. 13, 2005

(54) Portable cable reel

(76) Inventor: Lance Joseph, Hertfordshire (GB)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/844,499

(22) Filed: May 13, 2004

(30) Foreign Application Priority Data
May 13, 2003 (GB) GB 0311000.4

(51) Int. Cl. H02G 11/02

(52) U.S. Cl. 191/12.4

(57) ABSTRACT

A cable reel consisting of a housing which has at least one plug socket mounted within the housing, the socket is provided with apertures configured to receive the pins of a plug, the reel also includes a store of electric cable and a strap adapted to locate the cable reel adjacent to a user's body.

This application claims priority from British Application No. GB 0311000.4 of Lance JOSEPH filed May 13, 2003, titled PORTABLE CABLE REEL. The entirety of that application is incorporated herein by reference.

### BACKGROUND OF THE INVENTION

1. Field of the Invention

The present invention relates to a portable cable reel, particularly, but not exclusively to a portable cable reel for domestic and light industrial use.

2. Background of the Technology

Cable reels and socket extension apparatus have been available for some time and allow a user to enable the operation of an electric tool, for example a power tool, at locations distanced from a fixed power supply. Typically such cable reels and electrical socket extension apparatus consist of a housing having one or more plug sockets recessed therein, the sockets being connected to one end of a length of electric cable, the cable having a plug attached to its other end. The length of electric cable is commonly stored inside the housing and is deployed as required prior to connecting the plug of an electric tool into the socket of the reel.

Whilst these known cable reels and electric socket extension apparatus provide obvious advantages over the use of the electric cable of the power tool alone, they suffer from several drawbacks. Once such drawback is that a user is often required to estimate the length of cable which must be deployed or present between the cable reel and the fixed power supply. This drawback becomes conspicuous when the user realises that they desire a greater range of movement with the electric tool, thus requiring a greater length of cable to be deployed from the reel, and thus necessitating return trips to the reel to ensure a satisfactory length of cable is deployed. Equally, it can often be desirable for the length of deployed cable from the reel to be shortened to facilitate safe usage of the electric tool, also necessitating return trips to the reel.

### SUMMARY OF THE INVENTION

It is an object of the present invention to provide a cable reel which overcomes the problems of those known in the prior art.

Therefore, according to the present invention there is provided a cable reel comprising a housing, at least one plug socket mounted within the housing, the at least one socket being provided with apertures configured to receive the pins of a plug, a store of electric cable, and a strap adapted to locate the cable reel adjacent to a user's body.

It is to be noted that a term “cable reel” is used in relation to the present invention in a non-limiting sense; i.e. the term represents any device which comprises a housing within which is mounted at least one plug socket, wherein the plug socket is connected to a store of electric cable.

Preferably the store of electric cable is contained within the housing.

The store of electric cable can be accompanied by storage means to assist the compact storing thereof. The storage means may be any suitable means which facilitate the compact storage of the store of electric cable relative to the cable reel. One suitable storage means may be a rotateable drum around which the store of electric cable can be wound. Alternatively, the storage means can comprise suitable protruding limbs which extend outwardly from the housing around which the store of electric cable can be wound.

Control means can be provided to assist the deployment or the storage of the electric cable from the storage means. The control means preferably include a winding mechanism having a handle which the user can grip to provide the winding motion required for deployment or storage of the cable.

The cable reel may be provided with automatic retraction means. Such automatic retraction means may apply a constant retracting force on the cable, this force acting to return the cable into a tightly wound configuration around the drum or retention limb(s). The automatic retraction means may be provided with a suitable locking mechanism which is operable to lock the electric cable in a fixed position until such time as the locking mechanism is released.

In a first preferred embodiment, the strap is provided in the form of a shoulder strap. In a second preferred embodiment, the strap is provided in the form of a waist strap. In a third preferred embodiment, the strap is provided in the form of a wrist strap. In a fourth preferred embodiment, the strap is arranged such that it is capable of attachment to a user's belt. In a fifth preferred embodiment, the strap is arranged to be adjustable in length to allow it to be located adjacent to any part of the user's body.

In each of the preferred embodiments, the strap is capable of allowing the user to locate the reel adjacent to their body. Advantageously the provision of a strap, which allows a user to locate the reel adjacent to their body, permits a greater freedom of movement than is permitted by known cable reels. The user is able to cause the immediate deployment or retraction of the electric cable as desired for their particular need due to the adjacent location of the reel.

Furthermore, the cable reel of the present invention provides an increased level of safety over known cable reels since the user is able to connect and disconnect the plug of an electric tool more rapidly.

Ideally the cable reel is provided with fixing means which are capable of fixing the strap to any part of the reel. Preferably the strap is fixed to the reel at two separate fixing points. Alternatively, a looped strap can be fixed by a single fixing point to the reel. The strap may be provided with more than two fixing points however depending how the strap is to be located against the user's body.

Preferably the fixing means are used to fix the strap to the exterior of the housing. Alternatively, the fixing means may be present to fix the strap to the interior of the housing.

The housing can be made from any suitable material which is capable of protecting the contents of the housing from minor external impacts, such as the reel being dropped on a hard surface. Preferably the housing is made from a hard and/or resilient plastics material.

An abutment means may be provided to restrict the movement of the plug in relation to the housing, thus ensuring that the plug is easily available to the user when the electric cable is stored. The plug can be capable of acting as an abutment means by being brought to bear against the housing when the electric cable has been stored.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

In order to allow the present invention to be more readily understood a specific embodiment thereof will now be described with reference to the accompanying drawings in which:

FIG. 1 shows a perspective view of the first embodiment of the cable reel;

FIG. 2 shows a further perspective view of the first embodiment of the cable reel;

FIG. 3 shows a plan view of a second embodiment of the cable reel;

FIG. 4 shows a side elevation of a second embodiment of the cable reel;

FIG. 5 shows a perspective view of a third embodiment of the cable reel;

FIG. 6 shows a plan view of a fourth embodiment of the cable reel;

FIG. 7 shows a side elevation of the fourth embodiment of the cable reel;

FIG. 8 shows a perspective view of a fifth embodiment of the cable reel; and

FIG. 9 shows a further perspective view of the fifth embodiment of the cable reel.

### DETAILED DESCRIPTION

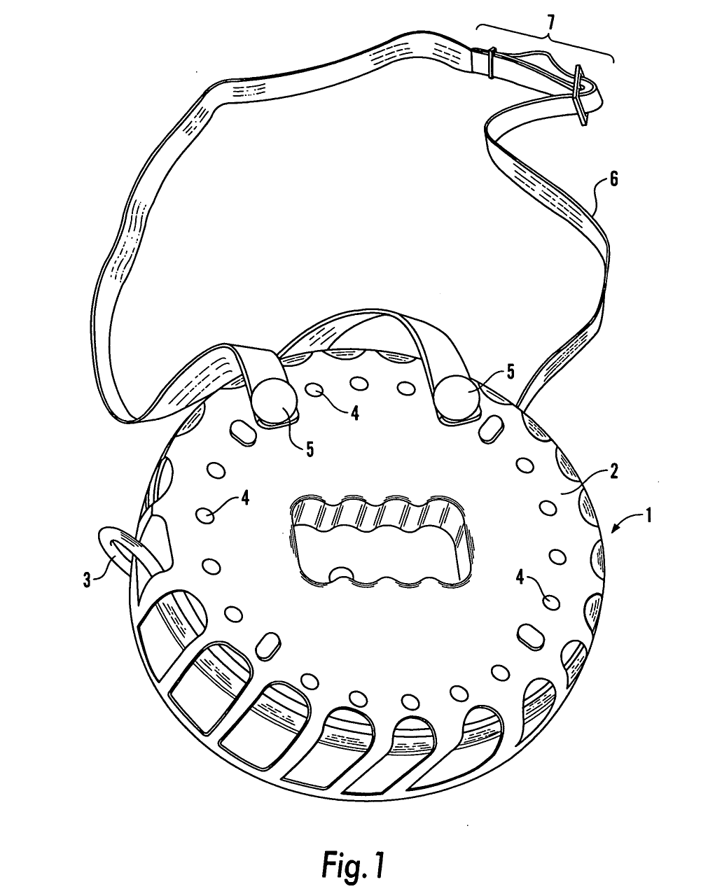

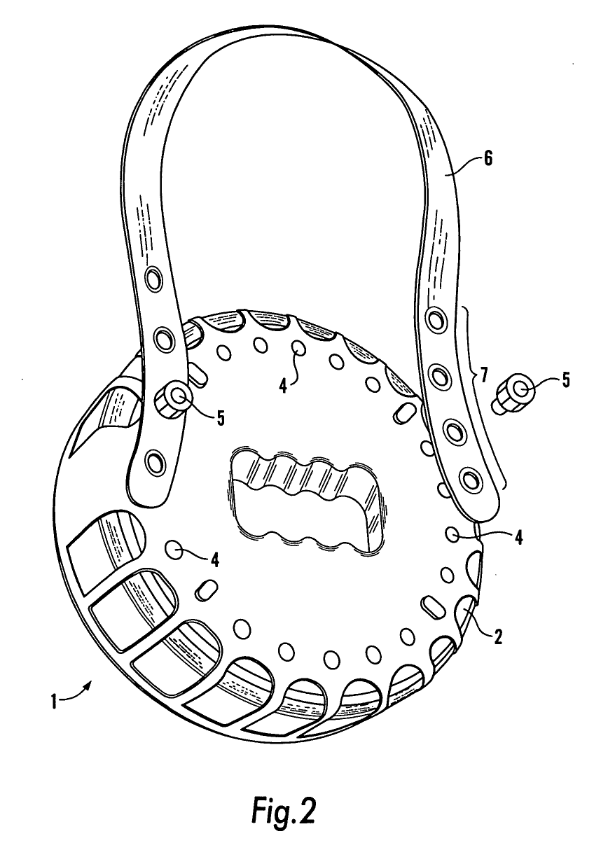

FIGS. 1 and 2 show a first embodiment of a cable reel 1 which possesses a housing 2 out of which protrudes an electric cable 3 which forms part of a store of cable contained within the housing. The rear side of cable reel 1 is provided with a series of fixing apertures 4 located around the circumference of the housing 2 (for the sake of clarity, not all of the fixing apertures 4 have been referenced). Each of the fixing apertures 4 is configured to receive and retain a fixing pin 5, the retention can be effective by any suitable means, such as a screw thread being present on the pin 5 engaging a corresponding thread in the aperture 4, a snap-fit arrangement etc. The cable reel 1 is also provided with a strap 6 which can be provided with a suitable adjusting arrangement 7.

The numerous fixing apertures 4 allow two parts of the strap to be fixed to the reel 1 in numerous confirmations depending on how a user wishes to locate the reel 1 adjacent to their body. The strap 6 is shown in a suitable arrangement to act as a shoulder strap or a waist strap.

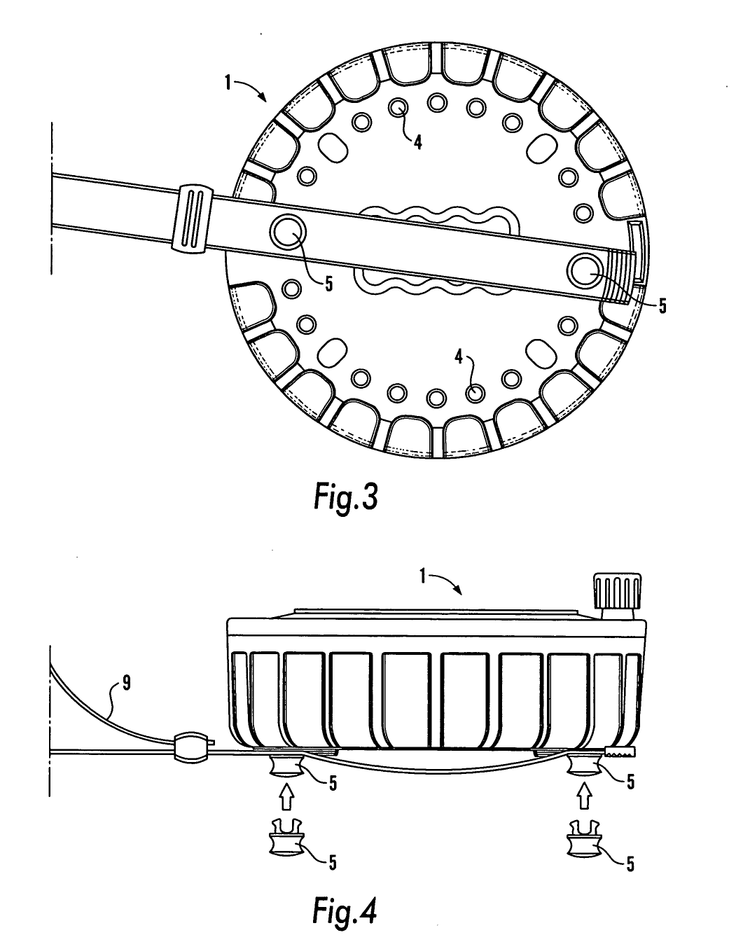

The adjusting arrangement 7 may be provided in the form of a folded configuration of the strap around a pair of buckles (as shown in FIG. 1) or by the presence of a series of holes in the strap through which the fixing pins 5 may pass (as shown in FIG. 2). Both of the adjusting arrangements 7 shown in FIGS. 1 and 2 allow the length of the strap to be adjusted to suit the user's requirements. FIGS. 3 and 4 show the reel 1 having a strap 8 which is fixed to the reel 1 by the retention of fixing pins 5 in the fixing apertures 4 in a different configuration to that shown in FIGS. 1 and 2.

It can be seen from FIG. 4 that the pins 5 include a pair of limbs which are capable of passing through an aperture in the strap 8 and into the aperture 4 such that the legs have a snap fit engagement therewith, and thus fixing the strap 8 to the reel 1. Whilst the strap 8 has two points of attachment to the reel 1, the user does not use the portion of the strap 8 between the two fixing points to locate the reel 1 against their body as shown in FIGS. 1 and 2. Rather, the strap 8 has at one end a looped arrangement 9 to allow the user to locate the reel 1 adjacent to their body.

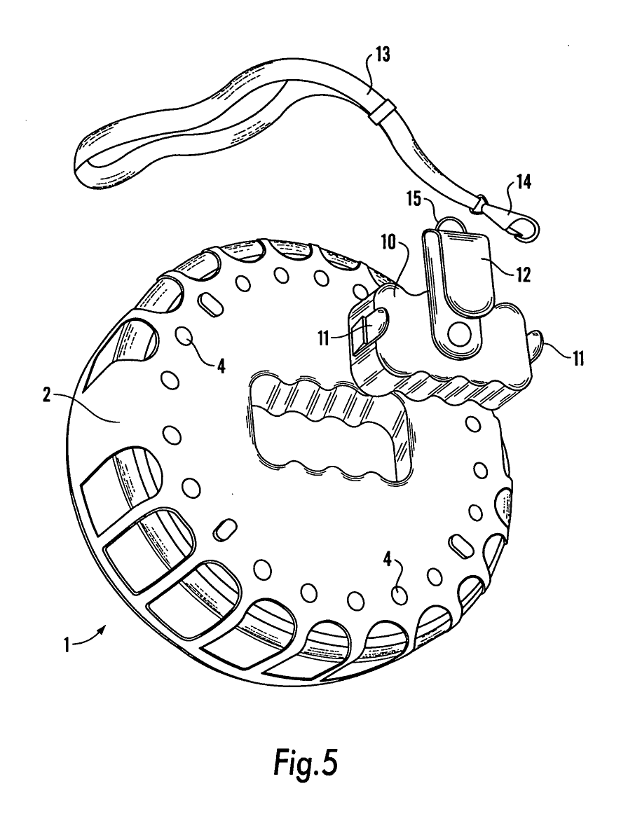

The third embodiment of the cable reel 1, shown in FIG. 5, illustrates two further variations of the strap. A block 10 is shown having a pair of securing clips 11. The block 10 is shaped to fit into a recessed portion of the reel 1 and the securing clips 11 are arranged to engage with a corresponding formation in the recessed portion to hold the block 10 in the reel 1 until such time as the securing clips 11 are released.

The block 10 is further provided with a strap 12 to allow a user to locate the reel 1 adjacent their body as shown in FIG. 5, the strap 12 can be shaped so that it can be looped over or around a user's belt in order to locate the reel 1 adjacent to the user's waist.

Additionally, the third embodiment of the reel 1 can be accompanied by a further strap 13 which has at one end a looped arrangement to allow a user to hold on to it and, at the other end, a spring loaded clasp 14 to allow the strap 13 to be fixed to the reel 1. In the arrangement shown in FIG. 5, the strap 12 can be provided with a loop 15 which the clasp 14 can be fixed to. However, the loop 15 could be formed as part of the housing 2 and the clasp 14 could be alternatively connected thereto.

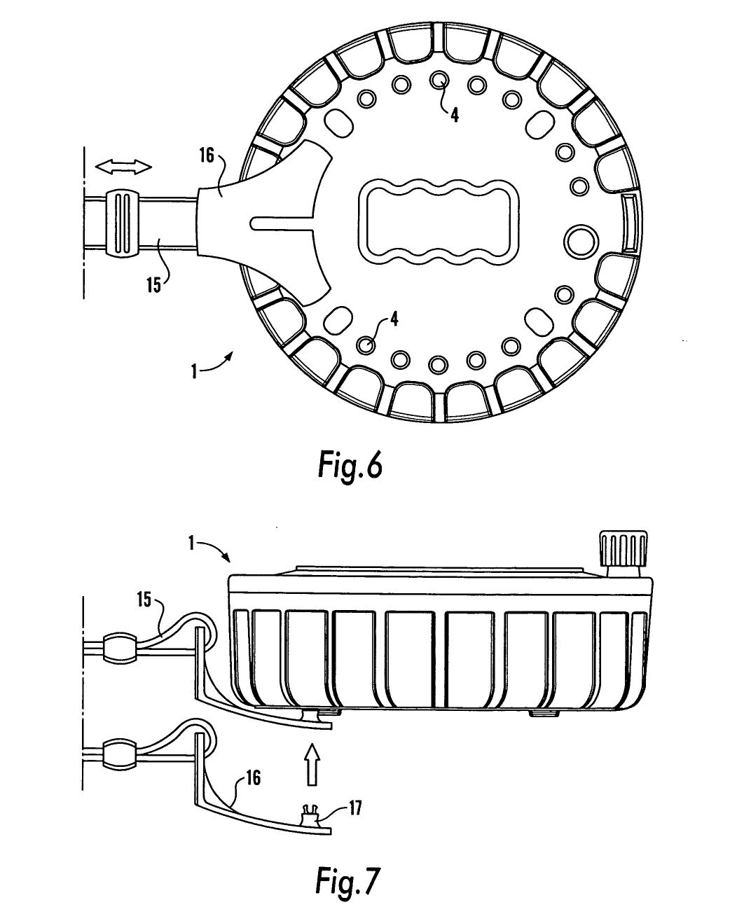

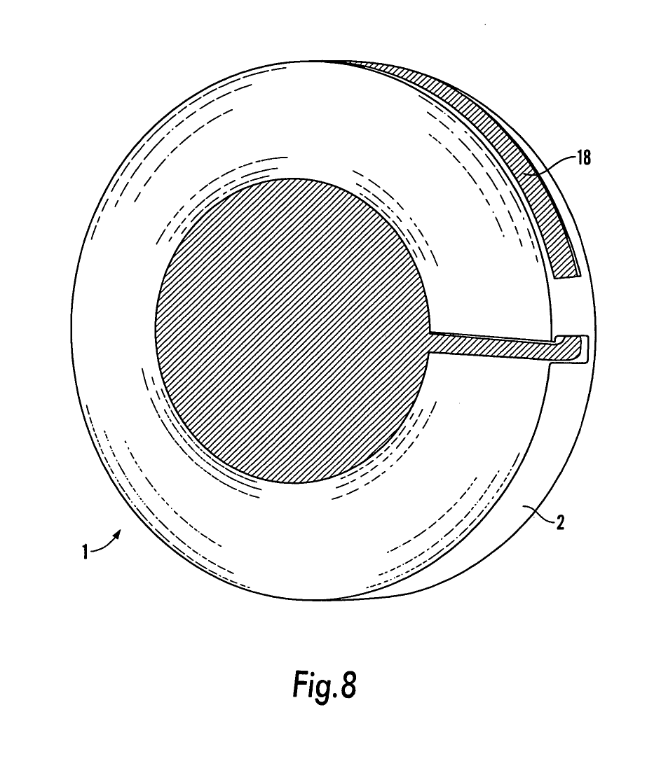

The embodiment of the cable reel 1 shown in FIGS. 6 and 7 includes a strap 15 which has, at one end, a looped arrangement to allow the user to hold on to it, and at the other end a further looped arrangement which engages a fixing formation 16. The fixing formation can be formed from any suitable hard or resilient material, such as a plastics material and includes a fixing pin 17 formed integrally therewith. Each formation 16 can have a pair of fixing pins 17, wherein each pin 17 has legs which protrude therefrom to form a snap fit connection with the interior of the fixing apertures 4 to attach the formation 16 to the reel 1.

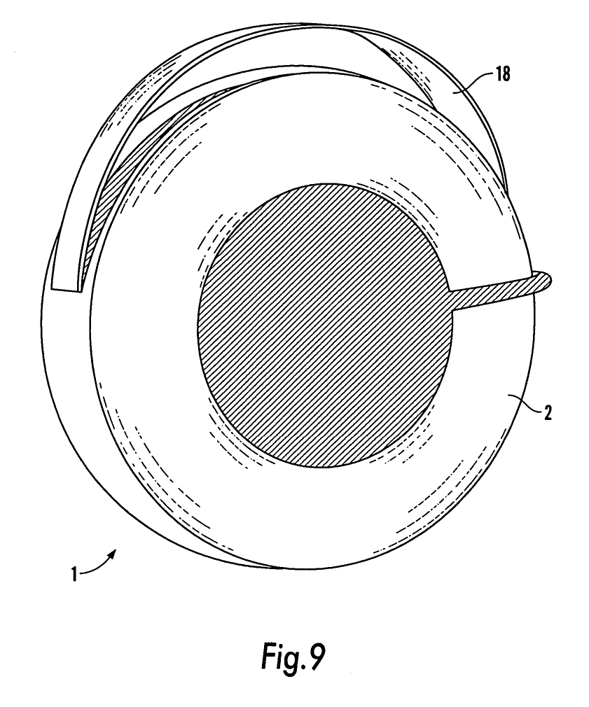

A fifth embodiment of the cable reel 1 is shown in FIGS. 8 and 9. In this embodiment the strap 18 is capable of being recessed into the housing 2. The strap 18 can be connected to a retraction mechanism (not shown) in the interior of the housing which acts to pull the strap 18 into the recess of the housing when the strap is not in use by a user.

As will be apparent to those skilled in the art, numerous modifications and variations can be made to the embodiments specifically described herein without departing from the invention.

1. A cable reel comprising a housing, at least one plug socket mounted within the housing, the at least one socket being provided with apertures configured to receive the pins of a plug, a store of electric cable, and a strap adapted to locate the cable reel adjacent to a user's body.

2. The cable reel according to claim 1, wherein the store of electric cable is contained within the housing.

3. The cable reel according to claim 1, wherein the store of electric cable is accompanied by storage means.

4. The cable reel according to claim 3, wherein the storage means is a rotateable drum around which the store of electric cable is wound.

5. The cable reel according to claim 3, wherein the storage means comprises protruding limbs which extend outwardly from the housing around which the store of electric cable is wound.

6. The cable reel according to claim 1, wherein control means are provided to facilitate the deployment or the storage of the electric cable from the storage means.

7. The cable reel according to claim 6, wherein the control means comprise a winding mechanism having a handle which the user can grip to provide the winding motion required for deployment or storage of the cable.

8. The cable reel according to claim 1, wherein the cable reel is provided with automatic retraction means.

9. The cable reel according to claim 8, wherein he automatic retraction means are provided with a locking mechanism, said locking mechanism being operable to lock the electric cable in a fixed position.

10. The cable reel according to claim 1, wherein the strap is provided in the form of a shoulder strap.

11. The cable reel according to claim 1, wherein the strap is provided in the form of a waist strap.

12. The cable reel according to claim 1, wherein the strap is provided in the form of a wrist strap.

13. The cable reel according to claim 1, wherein the strap is provided in the form capable of attachment to a user's belt.

14. The cable reel according to claim 1, wherein the strap is adjustable in length to allow it to be located adjacent to any part of the user's body.

15. The cable reel according to claim 1, wherein fixing means are provided, said fixing means being configured to permit the fixing the strap to any part of the reel.

16. The cable reel according to claim 1, wherein the strap is fixed to the reel at two separate fixing points.

17. The cable reel according to claim 1, wherein a looped strap is provided which is fixed by a single fixing point to the reel.

18. The cable reel according to claim 15, wherein the fixing means are used to fix the strap to the exterior of the housing.

19. The cable reel according to claim 15, wherein the fixing means are present to fix the strap to the interior of the housing.

20. The cable reel according to claim 1, wherein the housing is made from a hardened or resilient plastics material.

21. A cable reel according to claim 1, wherein an abutment means is provided to restrict the movement of the plug in relation to the housing.
